(19) United States
(12) Patent Application Publication
(10) Pub. No.: US 2006/0078987 A1
(43) Pub. Date: Apr. 13, 2006

(54) Compost Container

(76) Inventor: Paul Krier, Contern (LU)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/961,129

(22) Filed: Oct. 8, 2004

(51) Int. Cl. C05F 17/02

(52) U.S. Cl. 435/290.1

(57) ABSTRACT

A collapsible compost container is provided. The container has a hollow tubular body comprised of a flexible and breathable synthetic textile. Rigid first and second open end rims at opposite ends of the tubular body are connected by a helical spring that biases the open end rims away from each other so as to extend the tubular body of the compost container.

### FIELD OF THE INVENTION

This invention relates to a breathable and collapsible compost container. More particularly, the invention relates to a compost container comprised of synthetic porous sheet that can be collapsed for easy storage.

### BACKGROUND OF THE INVENTION

Households are increasingly composting organic house and garden wastes such as leaves, grass clippings, and kitchen wastes. Household and garden compost is commonly stored in rigid upright containers. For example, the compost container disclosed in U.S. Pat. No. 6,454,111 B1 has walls of wood boards mounted on vertical columns. Such rigid compost containers are difficult to move and store when not in use. Rigid compost containers also require significant floor space in the retail and wholesale establishments that sell them. Finally, rigid compost containers are relatively expensive to manufacture and install.

A compost container made of a fabric is disclosed in EP 1123909 B1. This compost container includes a tubular barrel portion fabricated of an air permeable material, and top and bottom lids that may be opened. The walls of the container are supported by the compost within the container that makes expansion zippers necessary so that the compost does not get stuck in the compost container. Because the walls of the compost container in EP 1123909 B1 are not self-supporting, it would be difficult to wash out and dry the container prior to storage.

There is a need for a strong, yet lightweight, compost container that can be readily folded or compacted during the marketing, sale and transport of the container. There is a further need for a compost container that readily expands to its full size and that supports itself when it is to be put into service.

### BRIEF DESCRIPTION OF THE DRAWINGS

A more thorough explanation of the invention will be provided in the detailed description of the preferred embodiments of the invention in which reference will be made to the following drawings:

FIG. 1 is a perspective view of a compost container according to one preferred embodiment of the invention.

FIG. 2 is a cross-sectional view taken along the line 2-2 of FIG. 1.

FIG. 3 is a perspective view of the compost container of FIG. 1, in which a top cover is shown on the top of the compost container.

FIG. 4 is a perspective view of the compost container of FIG. 1 in a partially collapsed state.

FIG. 5 is a perspective view of the compost container of FIG. 1 in a fully collapsed state.

### DETAILED DESCRIPTION

Reference will now be made in detail to the presently preferred embodiments of the invention, examples of which are illustrated below. The invention is directed to a compost container. According to the invention, the compost container comprises a hollow tubular body made of a flexible and breathable synthetic textile. The hollow tubular body has opposite first and second open ends. A rigid first open-end rim is integral with the first open end of the hollow tubular body, and a rigid second open-end rim is integral with the second open end of the hollow tubular body, and the first and second open-end rims are connected to each other by the hollow tubular body. A helical spring is connected to the first and second open-end rims. The helical spring is biased to separate the first and second open-end rims so as to extend the tubular body.

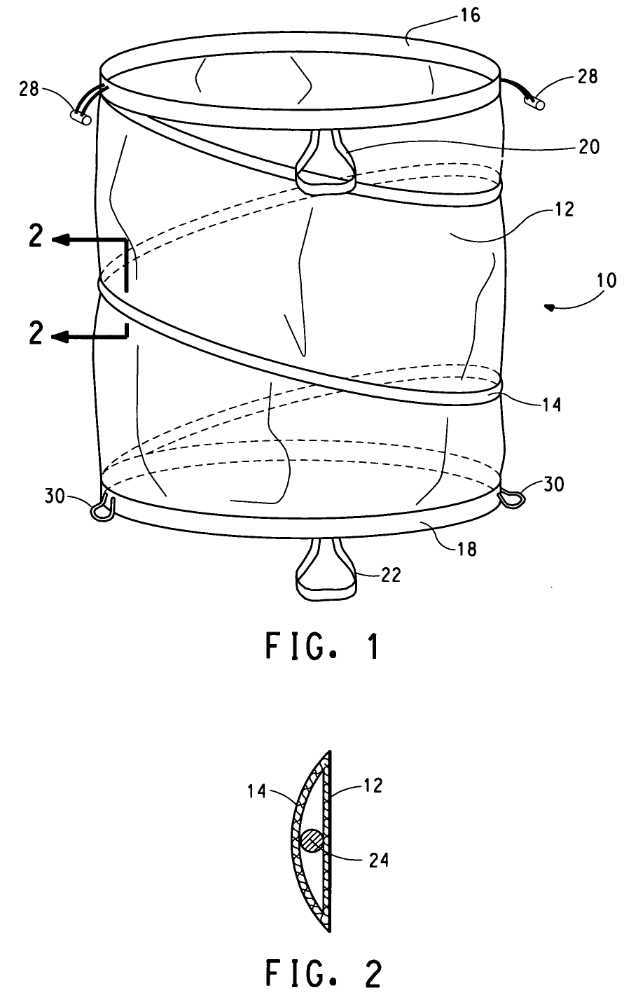

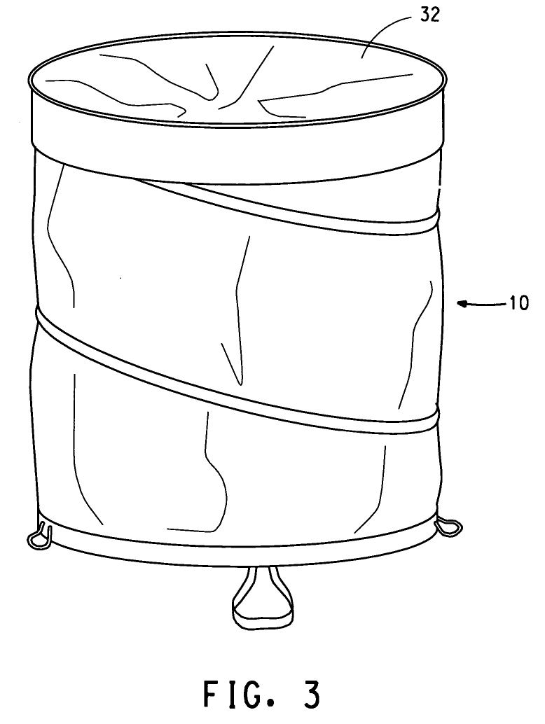

According to the preferred embodiment of the invention shown in FIGS. 1 to 5, the compost container 10 comprises a hollow tubular body 12 made of a flexible and breathable synthetic textile. The hollow tubular body has opposite first and second open ends. As shown in FIG. 1, a rigid fist open end rim 16 is integral with the first open end of the hollow tubular body, and a rigid second open end rim 18 is integral with the second open end of the hollow tubular body, and the first and second open end rims are connected to each other by the hollow tubular body 12. A helical spring 24, which is best seen in FIG. 2, connects the first and second open-end rims 16 and 18. The helical spring 24 is biased to separate the first and second open-end rims so as to extend the tubular body 12, as shown in FIG. 1. In a preferred embodiment of the invention, the compost container 10 has a diameter of from about 50 to 100 cm and a height of between 50 and 120 cm.

According to a preferred embodiment of the invention, the hollow tubular body is made of a synthetic nonwoven fabric with passages or pores that are sufficiently large to permit the passage of air. The synthetic nonwoven fabric is typically a spunbonded fabric or a needle-punched fabric. Preferably, the synthetic nonwoven fabric of the hollow tubular body 12 is a spunbonded nonwoven. A preferred spunbonded nonwoven is comprised of polyolefin polymer such as polyethylene or polypropylene homopolymers or copolymers. A light or medium weight spunbonded nonwoven with a basis weight of less than 130 grams per square meter, but that is also strong with a tensile strength of at least 3 KN/m is an ideal nonwoven fabric for the hollow tubular body 12 of the compost container of the invention. A preferred spunbonded polypropylene is Plantex® 3267-B spunbonded polypropylene made by DuPont and having a basis weight of 90 g/m², a tensile strength of 5.1 KN/m, and a very open structure.

According to the preferred embodiment of the invention, the helical spring is integral with the hollow tubular body. As can be seen in FIGS. 1 and 2, the helical spring 24, may be disposed in a helical pocket 14 that wraps around the hollow tubular body 12. The helical pocket 14 is preferably formed of a strip of synthetic nonwoven fabric that is stitched, adhesively bonded, or thermally bonded to the outer surface of the hollow tubular body 12. In one preferred embodiment of the invention, the helical pocket 14 and the tubular body 12 are comprised of the same synthetic nonwoven fabric.

According to one preferred embodiment of the invention, the helical spring and the first and second open rigid rims are comprised of metal, such as steel. The first and second open rigid rims are preferably comprised of a metal or a durable plastic.

According to the embodiment of the invention shown in FIG. 1, the first and second open rigid rims are substantially round and have substantially the same diameter, and the hollow tubular body connecting the first and second open rigid rims has a cylindrical shape. Alternatively, the rims may have another polygonal shape such as squares, rectangles, pentagons, hexagons or octagons. In another alternative embodiment, the first and second open rigid rims can have different diameters such that the hollow tubular body has a frustum shape. A frustum shape helps to reduce the possibility that compost will get stuck within the hollow tubular body of the compost container.

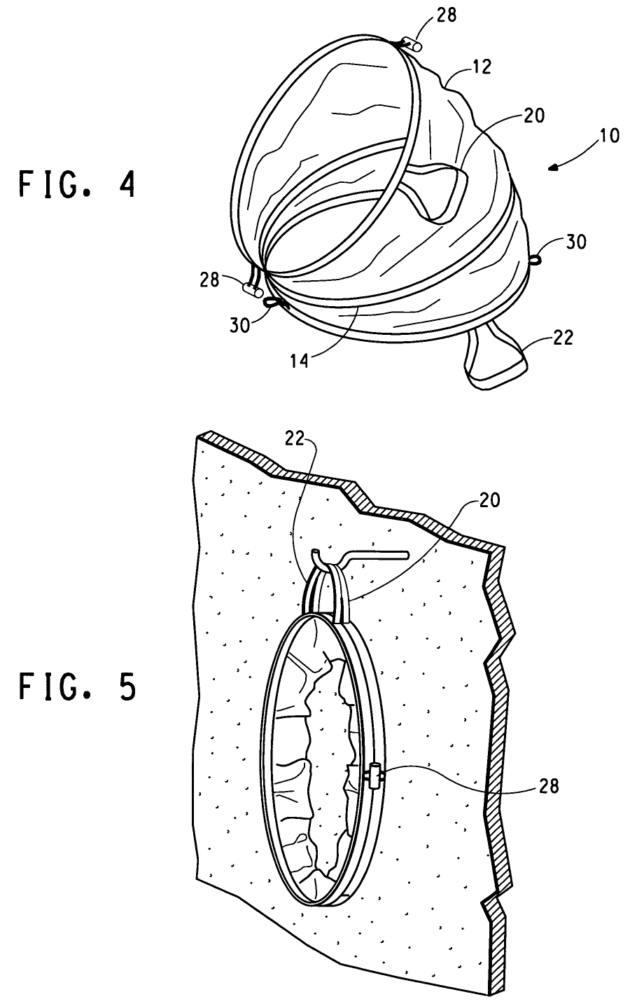

The compost container of the invention preferably has a fastener that may engage the first and second rigid rims when the helical spring is compressed so as to collapse the hollow tubular body. The fastener may comprise one or more ties, clips, latches or hooks. In the embodiment of the invention shown in FIG. 1, the fastner is comprised of the two toggles 28 on the rim 16 that respectively engage the two loops 30 on the opposite rim 18. When it is desired to store the compost container of the invention, the container is pushed down against the force of the helical spring as shown in FIG. 4. The toggles 28 are engaged by the loops 30 so as to hold the container in the compressed storage configuration shown in FIG. 5. The handles 20 and 22 provide a mechanism for hanging the compost container on a hook during storage.

According to a preferred embodiment of the invention, the compost container has a cover or lid that fits on the top of the compost container. In the embodiment of the invention shown in FIG. 3, a cover or lid 32 helps to contain odors arising from the compost, it helps the compost to retain moisture, and it protects the compost from animals. The cover or lid may have hooks, hinges or other connectors to hold the cover or lid in place on the compost container 10.

When it is desired to use the compost container of the invention, the container is opened to the extended position shown in FIG. 1 and it is placed outdoors at a composting location. Organic matter is periodically emptied into the container and the container is kept covered by the lid 32. The organic matter is left to biologically degrade. When it is desired to turn the compost, the compost container is lifted such that the compost is discharged out of the open bottom of the container. The compost can then be removed for use or it can be mixed and shoveled back into the compost container and covered for further composting.

Although particular embodiments of the present invention have been described in the foregoing description and drawings, it will be understood by those skilled in the art that the invention is capable of modifications, substitutions and rearrangements without departing from the spirit or essential attributes of the invention. Reference should be made to the appended claims, rather than to the foregoing specification, as indicating the scope of the invention.

What is claimed is:

1. A compost container comprising:
a hollow tubular body comprised of a flexible and breathable synthetic textile, said tubular body having opposite first and second open ends;
a rigid fist open end rim integral with the first open end of the hollow tubular body, and a rigid second open end rim integral with the second open end of the hollow tubular body, said first and second open end rims being connected to each other by said hollow tubular body;
a helical spring connected to said first and second open end rims, said helical spring being biased to separate said first and second open end rims so as to extend the tubular body.

2. The compost container of claim 1 wherein said helical spring is integral with the hollow tubular body.

3. The compost container of claim 2 wherein said hollow tubular body has a helical pocket extending as a band between the opposite ends of the hollow tubular body and the helical spring is disposed in the helical pocket.

4. The compost container of claim 1 wherein the hollow tubular body is made of a synthetic nonwoven fabric.

5. The compost container of claim 4 wherein the synthetic nonwoven fabric is a spunbonded nonwoven.

6. The compost container of claim 5 wherein the spunbonded nonwoven is comprised of a polyolefin.

7. The compost container of claim 6 wherein the spunbonded nonwoven has a basis weight of less than 130 grams per square meter and a tensile strength of at least 3 KN/m.

8. The compost container of claim 1 wherein said helical spring and said first and second open rigid rims are comprised of metal.

9. The compost container of claim 1 wherein said helical spring and said first and second open rigid rims are comprised of plastic.

10. The compost container of claim 1 wherein said first and second open rigid rims are substantially round and have substantially the same diameter, and wherein the hollow tubular body has a cylindrical shape.

11. The compost container of claim 1 wherein said first and second open rigid rims are substantially round and that different diameters, and wherein the hollow tubular body has a frustum shape.

12. The compost container of claim 1 further comprising a fastener that can engage the first and second rigid rims when the helical spring is compressed and the hollow tubular body is collapsed.

13. The compost container according to claim 12 wherein said fastener comprises a first toggle connected to said first rigid rim and a complementary loop connected to said second rigid rim for receiving the toggle when said first and second rigid rims are engaged to each other.

14. The compost container according to claim 1 further comprising of a lid sized to cover the first open end of said hollow tubular body.
